(19) United States
(12) Patent Application Publication
(10) Pub. No.: US 2011/0247108 A1
(43) Pub. Date: Oct. 6, 2011

(54) Sample inspection apparatuses and sample inspection methods

(75) Inventor: Yonmook Park, Suwon-si (KR)

(73) Assignee: Samsung Electronics Co., Ltd., Suwon-si (KR)

(21) Appl. No.: 13/064,309

(22) Filed: Mar. 17, 2011

(30) Foreign Application Priority Data
Apr. 2, 2010 (KR) 10-2010-0030375

(51) Int. Cl. G01Q 60/00

(52) U.S. Cl. 850/21

(57) ABSTRACT

Sample inspection apparatuses and sample inspection methods which may include scanning a sample at high speed while inducing electrostatic force due to an electric field generated between a probe tip and the sample and generating and displaying a surface topography of the sample from a vibration displacement variation of a cantilever due to the electrostatic force.

### CROSS-REFERENCE TO RELATED APPLICATION

This application claims priority under 35 U.S.C. §119 to Korean Patent Application No. 2010-0030375, filed on Apr. 2, 2010 in the Korean Intellectual Property Office (KIPO), the entire contents of which is incorporated herein by reference.

### BACKGROUND

1. Field

Example embodiments relate to sample inspection apparatuses and sample inspection methods which may detect sample defects by imaging a surface topography of a sample.

2. Description of the Related Art

In general, in order to achieve high integration and high performance of semiconductor devices, correct formation of a thin film pattern on a sample (e.g., a wafer) may be important. For this purpose, an inspection process to judge whether or not the thin film pattern is correctly formed on the wafer may be required. For example, defects, such as particles or micro scratches, may be generated on the pattern formed on the wafer through a pattern process, or defects may be generated on the pattern formed on the wafer through a chemical mechanical polishing (CMP) process. Apparatuses mainly used to inspect defects on a wafer may include wafer inspection apparatuses using an electron beam and wafer inspection apparatuses using an optical system.

A wafer inspection process of a wafer inspection apparatus using an electron beam may include the following steps. A wafer may be mounted on a stage in a chamber and fixed using a chuck. The inside of the chamber may be evacuated by operating a vacuum pump. A scanner may scan the wafer while irradiating an electron beam generated from an electron beam column attached to the scanner onto the wafer. A detector may detect secondary electrons due to interaction between the wafer and the electron beam. An image processor may image a secondary electron detection signal detected by the detector. A display may display defects of the wafer in response to the signal from the image processor.

A wafer inspection process of a wafer inspection apparatus using an optical system may include the following steps. A wafer may be mounted on a stage and fixed using a chuck. A scanner may scan the wafer using an optical system attached to the scanner. An image processor may image a signal of the optical system. A display may display wafer defects in response to the signal from the image processor.

A wafer inspection apparatus using an electron beam may be operated in a vacuum state in view of physical characteristics of the electron beam, and may scan the wafer while irradiating the electron beam to the surface of the wafer and detect secondary electrons emitted due to destruction of the surface of the wafer. Therefore, such a wafer inspection apparatus may require a vacuum inside a chamber obtained by operating a vacuum pump under a condition that the wafer is placed in the chamber, thereby influencing an inspection time of the wafer. Further, the electron beam may destroy the surface of the wafer, and thus the wafer may be damaged. A wafer inspection apparatus using an optical system may have limited resolution for detection of defects of the wafer in view of physical characteristics of the optical system, and thus fine defects of the wafer may not be detected.

### SUMMARY

Example embodiments may provide sample inspection apparatuses and sample inspection methods which may measure a surface topography of a sample to rapidly and precisely detect sample defects without damage to the surface of the sample. Other example embodiments may provide sample inspection apparatuses and sample inspection methods which may measure a surface potential and/or a capacitance of a sample to inspect whether or not substances constituting the sample are uniformly distributed.

According to example embodiments, a sample inspection apparatus includes a probe tip, a cantilever provided with the probe tip, a vibration displacement of the cantilever being varied by electrostatic force induced between the probe tip and a sample, a displacement sensor to measure the vibration displacement of the cantilever, an actuator to vibrate the cantilever, a quartz resonator scanner to vibrate the cantilever in a scanning direction of the sample, a voltage supplier supplying voltage to the probe tip and the sample to induce the electrostatic force, and a controller to actuate the actuator and the quartz resonator scanner so as to scan the sample, and to control generation of a surface topography of the sample according to the vibration displacement of the cantilever measured by the displacement sensor when the sample is scanned.

The controller may include a first lock-in amplifier to output an amplitude and a phase of the cantilever corresponding to the surface topography of the sample from the vibration displacement of the cantilever measured by the displacement sensor, and generate the surface topography of the sample from the amplitude and the phase of the cantilever output from the first lock-in amplifier. The sample inspection apparatus may include a surface topography display to display the surface topography of the sample generated by the controller. The controller may include a second lock-in amplifier to output an amplitude and a phase of the cantilever corresponding to a surface potential of the sample from the vibration displacement of the cantilever measured by the displacement sensor, and generate the surface potential of the sample from the amplitude and the phase of the cantilever output from the second lock-in amplifier.

The controller may include a third lock-in amplifier to output an amplitude and a phase of the cantilever corresponding to a capacitance of the sample from the vibration displacement of the cantilever measured by the displacement sensor, and generate the capacitance of the sample from the amplitude and the phase of the cantilever output from the third lock-in amplifier. The actuator may vibrate the cantilever in a direction of the Z-axis, and the quartz resonator scanner may vibrate the cantilever in a direction of the Y-axis. The sample inspection apparatus may include a main scanner to move the quartz resonator scanner in directions of the X-axis, the Y-axis, and the Z-axis, and to rotate the quartz resonator scanner in the direction of the Z-axis, and the main scanner may move in the direction of the X-axis when the sample is scanned.

The sample inspection apparatus may include a stage to move the sample in directions of the X-axis, the Y-axis, and the Z-axis, and to rotate the sample in the direction of the Z-axis, and the stage may move in the direction of the X-axis when the sample is scanned. The sample inspection apparatus may include an implement to attach the quartz resonator scanner to the main scanner. The surface of the cantilever may be coated with an insulating oxide layer so as to prevent electrical short between the cantilever and the sample generated when the cantilever physically contacts the sample.

According to other example embodiments, a sample inspection method includes a probe tip, a cantilever provided with the probe tip, a vibration displacement of the cantilever being varied by electrostatic force induced between the probe tip and a sample, a displacement sensor to measure the vibration displacement of the cantilever, an actuator to vibrate the cantilever, a quartz resonator scanner to vibrate the cantilever in a scanning direction of the sample, a voltage supplier supplying voltage to the probe tip and the sample to induce the electrostatic force, and a controller to actuate the actuator and the quartz resonator scanner so as to scan the sample, and to control generation of a surface topography, a surface potential, and a capacitance of the sample according to the vibration displacement of the cantilever measured by the displacement sensor when the sample is scanned.

The controller may include a first lock-in amplifier to output an amplitude and a phase of the cantilever corresponding to the surface topography of the sample from the vibration displacement of the cantilever measured by the displacement sensor, a second lock-in amplifier to output an amplitude and a phase of the cantilever corresponding to the surface potential of the sample from the measured vibration displacement of the cantilever, and a third lock-in amplifier to output an amplitude and a phase of the cantilever corresponding to the capacitance of the sample from the measured vibration displacement of the cantilever. The controller may generate the surface topography of the sample according to an output signal of the first lock-in amplifier, generate the surface potential of the sample according to an output signal of the second lock-in amplifier, and generate the capacitance of the sample according to an output signal of the third lock-in amplifier. The sample inspection apparatus may include displays to respectively display the surface topography, the surface potential, and the capacitance of the sample according to a control signal of the controller.

According to still other example embodiments, a sample inspection method includes supplying voltage to a sample and a probe tip provided on a cantilever, vibrating the cantilever at a constant vibration displacement, scanning the sample using a quartz resonator scanner vibrating the cantilever in a direction parallel with the sample, measuring the vibration displacement of the cantilever when the sample is scanned, generating a surface topography of the sample based on the measured vibration displacement of the cantilever, and displaying the generated surface topography.

The scanning of the sample may include vibrating the cantilever in the direction parallel with the sample through the quartz resonator scanner before the scanning of the sample, measuring the vibration displacement of the cantilever in the direction parallel with the sample, and adjusting a vibration displacement of the scanner such that the measured vibration displacement reaches a predetermined displacement. The sample inspection method may include generating a surface potential of the sample based on the measured vibration displacement of the cantilever, and displaying the generated surface potential. The sample inspection method may include generating a capacitance of the sample based on the measured vibration displacement of the cantilever, and displaying the generated capacitance.

According to further example embodiments, a sample inspection apparatus includes a cantilever including a probe tip, the cantilever configured such that a vibration displacement of the cantilever varies according to electrostatic force induced between the probe tip and a sample, a displacement sensor configured to measure the vibration displacement of the cantilever, an actuator configured to vibrate the cantilever, a first scanner configured to vibrate the cantilever in a scanning direction of the sample, a voltage supply configured to supply voltage to the probe tip and the sample to induce the electrostatic force and a controller configured to actuate the actuator and the first scanner to scan the sample and to control generation of surface topography data of the sample based on the vibration displacement measured during scanning of the sample.

According to still further example embodiments, a sample inspection apparatus includes a cantilever including a probe tip, the cantilever configured such that a vibration displacement of the cantilever varies according to electrostatic force induced between the probe tip and a sample, a displacement sensor configured to measure the vibration displacement of the cantilever, an actuator configured to vibrate the cantilever, a quartz resonator scanner configured to vibrate the cantilever in a scanning direction of the sample, a voltage supply configured to supply voltage to the probe tip and the sample to induce the electrostatic force and a controller configured to actuate the actuator and the quartz resonator scanner to scan the sample and to control generation of surface topography data, surface potential data, and capacitance data of the sample based on the vibration displacement measured during scanning of the sample.

According to yet further example embodiments, a sample inspection method includes supplying voltage to a sample and to a probe tip of a cantilever, vibrating the cantilever to obtain an about constant vibration displacement, scanning the sample using a quartz resonator scanner that vibrates the cantilever in a direction parallel with the sample, measuring the vibration displacement of the cantilever during the scanning of the sample, generating surface topography data corresponding to a surface topography of the sample based on the measured vibration displacement of the cantilever and displaying the surface topography data.

### BRIEF DESCRIPTION OF THE DRAWINGS

Example embodiments will be more clearly understood from the following brief description taken in conjunction with the accompanying drawings. FIGS. 1-4B represent non-limiting, example embodiments as described herein.

FIG. 1 is a schematic perspective view illustrating configurations of sample inspection apparatuses according to example embodiments;

FIG. 2 is a perspective view illustrating methods of scanning samples using sample inspection apparatuses according to other example embodiments;

FIG. 3 is a perspective view illustrating methods of scanning samples using sample inspection apparatuses according to still other example embodiments; and

FIGS. 4A and 4B are flow charts illustrating sample inspection methods using sample inspection apparatuses according to yet other example embodiments.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments will now be described more fully with reference to the accompanying drawings, in which example embodiments are shown. Example embodiments may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used herein, a sample may refer to a sample that is not a manufactured part or to a sample of a manufactured part selected for inspection. The term sample is not used to limit, for example, a measured object to a particular type of object, but only to indicate that the object is measured.

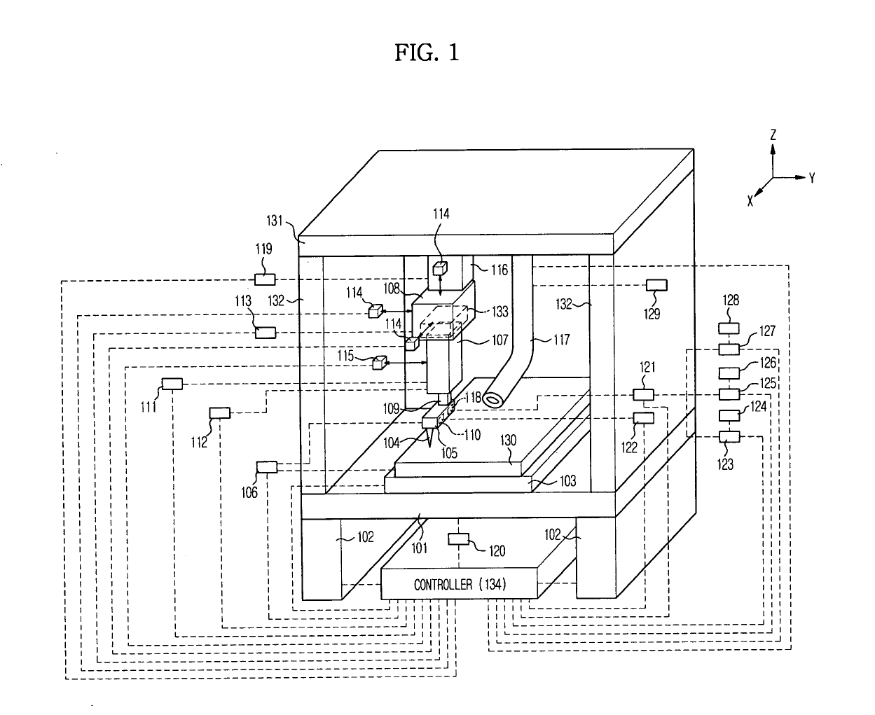

FIG. 1 is a schematic perspective view illustrating configurations of sample inspection apparatuses in accordance with example embodiments. Referring to FIG. 1, a sample inspection apparatus may include a stage 101, isolators 102, a chuck 103, a probe tip 104, a cantilever 105, a voltage supplier 106, a quartz resonator scanner 107, a main scanner 108 and a cantilever fixing module 109. The stage 101 may transfer a sample 130 (e.g., a target to be measured) in the X-axis, Y-axis, and Z-axis directions, and rotate the sample 130 in the Z-axis direction.

The isolators 102 may be under a lower surface of the stage 101 and may control vibration of the stage 101. The chuck 103 may be on an upper surface of the stage 101, and may fix the sample 130 to the stage 101. The chuck 103 may include any tool to fix the sample 130 to the stage 101. For example, the chuck 103 may be an electrostatic chuck to fix the sample 130 using electrostatic force, a vacuum chuck to suck air at a contact portion with the sample 130 to fix the sample 130 and/or a clip to mechanically fix the sample 130. The probe tip 104 may induce electrostatic force and Van der Waals force with the sample 130 mounted on the chuck 103. When the probe tip 104 is close to the surface of the sample 130, interactions between atoms of the probe tip 104 and atoms of the surface of the sample 130 may occur. The cantilever 105 connected to the probe tip 104 may be bent upward and downward. Such interaction may be referred to as Van der Waals force.

The cantilever 105 including a free terminal, to which the probe tip 104 is attached, may have an actuation displacement and an operating frequency, varied by electric force and Van der Waals force with the sample 130. One or more probe tips 104 and one or more cantilevers 105 may be provided. The cantilever 105 may include an actuator 110 to vibrate the cantilever 105 and a displacement sensor 118 to measure a vibration displacement of the cantilever 105. For example, the actuator 110 may vibrate the cantilever 105 in the direction of the Z-axis. The displacement sensor 118 may measure a vibration displacement of the cantilever 105 in the direction of the Z-axis. Hereinafter, for convenience of description, the actuator 110 may be described as a Z-axis actuator, and the displacement sensor 118 may be described as a Z-axis displacement sensor, although example embodiments are not so limited.

The Z-axis actuator 110 may include a piezoelectric actuator and/or a thermal actuator, and may vibrate the cantilever 105 at high speed in the Z-axis direction. The piezoelectric actuator may be an actuator using a piezoelectric material, which has an actuation displacement varied when voltage is applied thereto, and the thermal actuator may be an actuator using a bimetal material, which has an actuation displacement varied due to a bimetal effect when voltage is applied to materials having different thermal expansion coefficients. The Z-axis displacement sensor 118 may include a piezo resistive sensor. The piezo resistive sensor may be a sensor in which resistance of a piezoelectric material is varied according to variation of a displacement of the piezoelectric material. When voltage is supplied to the piezoelectric actuator and/or the thermal actuator of the cantilever 105, the cantilever 105 may reciprocate between the positive Z-axis and the negative Z-axis (e.g., vibrate). When the cantilever 105 vibrates, a resistance value of the piezo resistive sensor may be varied. The actuation displacement of the cantilever 105 may be measured by sensing variation of the output of the piezo resistive sensor.

In order to prevent and/or reduce electrical shorts between the cantilever 105 and the sample 130 if the cantilever 105 and the sample 130 come into physical contact, the surface of the cantilever 105 may be coated with an insulating oxide layer. The cantilever 105 may include a Z-axis actuator 110 and/or a piezoelectric motor between the cantilever 105 and the quartz resonator scanner 107, and may vibrate the cantilever 105 at high speed in the Z-axis direction. The voltage supplier 106 may supply voltage to the sample 130 and the cantilever 105 to generate electrostatic force between the sample 130 and the cantilever 105. The quartz resonator scanner 107 may scan the sample 130 at a high speed in the direction of the Y-axis using a quartz resonator, which is actuatable at high speed of several MHz in the direction of the Y-axis. The main scanner 108 may move the quartz resonator scanner 107 in the X-axis, Y-axis, and Z-axis directions, rotate the quartz resonator scanner 107 in the Z-axis direction, and scan the sample 130.

The cantilever fixing module 109 may be under a lower surface of the quartz resonator scanner 107, and may fix the cantilever 105. A sample inspection apparatus in accordance with example embodiments may include a voltage supplier 111 for the quartz resonator scanner 107, a current measuring device 112 for the quartz resonator scanner 107, an amplifier 113 for the main scanner 108, a displacement measuring device 114 for the main scanner 108, a displacement measuring device 115 for the quartz resonator scanner 107, a coarse approach system 116, an optical system 117, an amplifier 119 for the coarse approach system 116, an amplifier 120 for the stage 101, an amplifier 121 for the cantilever displacement sensor 118, an amplifier 122 for the cantilever actuator 110, a sample surface topography lock-in amplifier 123, a sample surface topography display 124, a sample surface potential lock-in amplifier 125, a sample surface potential display 126, a sample capacitance lock-in amplifier 127, a sample capacitance display 128, an optical image display 129, a crossbeam 131, columns 132, and an implement 133 for attachment of the quartz resonator scanner 107.

The voltage supplier 111 for the quartz resonator scanner 107 may supply voltage to the quartz resonator of the quartz resonator scanner 107 to actuate the quartz resonator scanner 107 at a high speed. When the voltage supplier 111 for the quartz resonator scanner 107 supplies voltage to the quartz resonator of the quartz resonator scanner 107, the quartz resonator may be actuated at a high speed of several MHz while reciprocating between the positive Y-axis and the negative Y-axis, and the quartz resonator scanner 107 may be vibrated at a high speed in the direction of the Y-axis. The current measuring device 112 for the quartz resonator scanner 107 may measure current generated while the quartz resonator scanner 107 is actuated. The amplifier 113 for the main scanner 108 may supply voltage to the main scanner 107 to actuate the main scanner 108 in the X-axis, Y-axis, and Z-axis directions, and to rotate the main scanner 108 in the Z-axis direction.

The displacement measuring device 114 for the main scanner 108 may measure actuation displacements of the main scanner 108 in the X-axis, Y-axis, and Z-axis directions, and a rotation displacement of the main scanner 108 in the Z-axis direction. The displacement measuring device 115 for the quartz resonator scanner 107 may measure an actuation displacement of the quartz resonator scanner 107 in the Y-axis direction. The coarse approach system 116 may include a motor and a gear, and may transfer the quartz resonator scanner 107 and the main scanner 108 in the Z-axis direction to enable the quartz resonator scanner 107 and the main scanner 108 to approach the sample 130.

The optical system 117 may capture an image using a charge coupled device (CCD) sensor and a lens so as to check whether or not the cantilever 105 approaches a desired position of the sample 130. The amplifier 119 for the coarse approach system 116 may supply voltage to the coarse approach system 116 to move the coarse approach system 116 in the Z-axis direction. The amplifier 120 for the stage 101 may supply power to the stage 101 to actuate the stage 101 in the X-axis, Y-axis, and Z-axis directions, and to rotate the stage 101 in the direction of the Z-axis. The amplifier 121 for the cantilever displacement sensor 118 may amplify an output value of the Z-axis displacement sensor 118 of the cantilever 105 to measure an actuation displacement of the cantilever 105 in the direction of the Z-axis.

The amplifier 122 for the cantilever actuator 110 may supply power to the Z-axis actuator 110 of the cantilever 105 to actuate the cantilever 105 in the direction of the Z-axis. The sample surface topography lock-in amplifier 123 may output an amplitude and a phase of the cantilever 105 required to image a surface topography of the sample 130 using an output value of the Z-axis displacement sensor 118 of the cantilever 105. The sample surface topography display 124 may image the surface topography of the sample 130 using an output signal of the sample surface topography lock-in amplifier 123. The sample surface potential lock-in amplifier 125 may output an amplitude and a phase of the cantilever 105 required to image a surface potential of the sample 130 using the output value of the Z-axis displacement sensor 118 of the cantilever 105.

The sample surface potential display 126 may image the surface potential of the sample 130 using an output signal of the sample surface potential lock-in amplifier 125. The sample capacitance lock-in amplifier 127 may output an amplitude and a phase of the cantilever 105 required to image a capacitance of the sample 130 using the output value of the Z-axis displacement sensor 118 of the cantilever 105. The sample capacitance display 128 may image the capacitance of the sample 130 using an output signal of the sample capacitance lock-in amplifier 127. The optical image display 129 may image approach of the cantilever 105 to the desired position of the sample 130 using an output signal of the optical system 117. The coarse approach system 116 may be attached to the crossbeam 131.

The columns 132 may support the crossbeam 131. The implement 133 for attachment of the quartz resonator scanner 107 may attach the quartz resonator scanner 107 to the main scanner 108. Because the quartz resonator scanner 107 may be attached to the main scanner 108 by the implement 133 for attachment of the quartz resonator scanner 107, when the main scanner 108 is actuated in the X-axis, Y-axis, and the Z-axis direction and rotated in the direction of the Z-axis, the quartz resonator scanner 107 may be actuated in the directions of the X-axis, the Y-axis, and the Z-axis and be rotated in the direction of the Z-axis.

If the quartz resonator scanner 107 is attached to the main scanner 108 using the implement 133 for attachment of the quartz resonator scanner 107, the center of mass of the quartz resonator scanner 107 and the center of mass of the main scanner 108 may nearly coincide with each other, thereby reducing vibration induced by actuations of the main scanner 108 and the quartz resonator scanner 107. Further, the implement 133 for attachment of the quartz resonator scanner 107 may be designed such that stiffness of the implement 133 for attachment of the quartz resonator scanner 107 in the X-axis, Y-axis, and Z-axis directions is high, thereby raising natural resonance frequency of the implement 133 for attachment of the quartz resonator scanner 107 and reducing vibration of the implement 133 for attachment of the quartz resonator scanner 107 induced by vibration less than the natural resonance frequency of the implement 133 for attachment of the quartz resonator scanner 107.

The implement 133 for attachment of the quartz resonator scanner 107 may be designed such that deformation of the implement 133 for attachment of the quartz resonator scanner 107 in the X-axis, Y-axis, and Z-axis directions is small, thereby reducing deformation of the implement 133 for attachment of the quartz resonator scanner 107 induced by actuations of the quartz resonator scanner 107 and the main scanner 108. The quartz resonator scanner 107 and the main scanner 108 may be designed such that stiffness of the quartz resonator scanner 107 and the main scanner 108 in the X-axis, Y-axis, and Z-axis directions is high, thereby raising natural resonance frequencies of the quartz resonator scanner 107 and the main scanner 108 and reducing vibration of the quartz resonator scanner 107 and the main scanner 108 induced by vibration less than the natural resonance frequencies of the quartz resonator scanner 107 and the main scanner 108.

The quartz resonator scanner 107 and the main scanner 108 may be designed such that deformation of the quartz resonator scanner 107 and the main scanner 108 in the X-axis, Y-axis, and Z-axis is small, thereby reducing deformation of the quartz resonator scanner 107 and the main scanner 108, induced by actuations of the quartz resonator scanner 107 and the main scanner 108. The sample inspection apparatus in accordance with example embodiments may include a controller 134 to control operations of the respective components. The controller 134 may include the sample surface topography lock-in amplifier 123, the sample surface potential lock-in amplifier 125, and the sample capacitance lock-in amplifier 127. Because the quartz resonator scanner 107 may be attached to the main scanner 108 by the implement 133 for attachment of the quartz resonator scanner 107, the controller 134 may move the main scanner 108 in the X-axis, Y-axis, and Z-axis directions and rotate the main scanner 108 in the direction of the Z-axis, thereby moving the quartz resonator scanner 107 in the X-axis, Y-axis, and Z-axis directions, and rotating the quartz resonator scanner 107 in the Z-axis direction.

The controller 134 may measure actuation displacements of the main scanner 108 in the X-axis, Y-axis, and Z-axis directions, and a rotation displacement of the main scanner 108 in the Z-axis direction, through the displacement measuring device 114 for the main scanner 108. The controller 134 may adjust voltage of the voltage supplier 111 for the quartz resonator scanner 107 to allow the output value of the current measuring device 112 for the quartz resonator scanner 107 and/or the output value of the displacement measuring device 115 for the quartz resonator scanner 107 to remain constant, thereby constantly controlling actuation displacement of the quartz resonator scanner 107 and constantly adjusting an Y-axis scan region of the sample 130. Because current may be generated from the quartz resonator due to a piezoelectric effect of the quartz resonator when the displacement of the quartz resonator is changed due to the actuation of the quartz resonator, the controller 134 may measure the current generated from the quartz resonator through the current measuring device 112 for the quartz resonator scanner 107, thereby sensing the actuation displacement of the quartz resonator scanner 107.

The controller 134 may actuate the coarse approach system 116, the stage 101, and the main scanner 108 so as to allow the cantilever 105 to be located at a desired position of the sample 130, while checking images of the cantilever 105 and the sample 130 using the optical system 117 and the optical image display 129. The controller 134 may scan the sample 130.

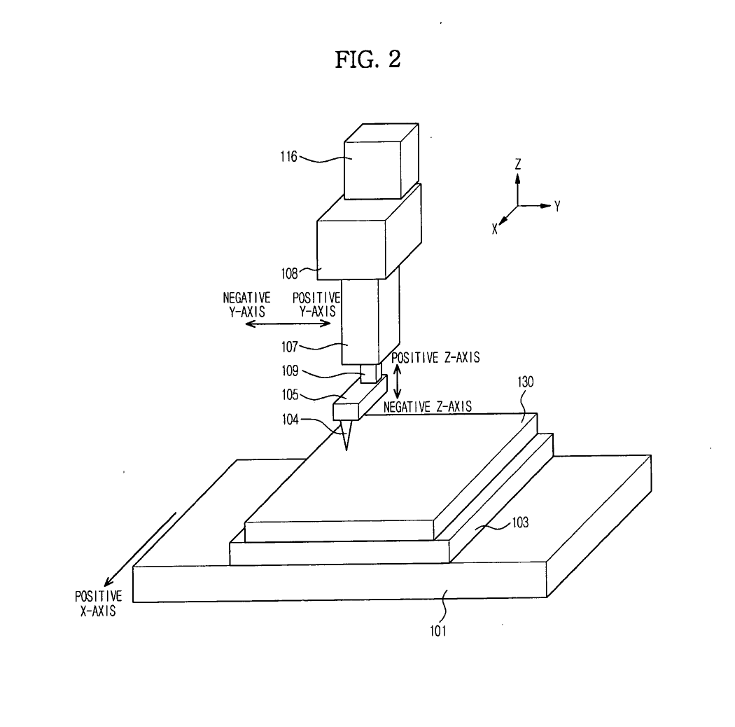

FIG. 2 is a perspective view illustrating methods of scanning samples using sample inspection apparatuses in accordance with other example embodiments. Referring to FIG. 2, the sample 130 may be scanned by vibrating the quartz resonator scanner 107 at a high speed in the positive Y-axis and negative Y-axis directions, actuating the Z-axis actuator of the main scanner 108 and/or the piezoelectric actuator and/or the thermal actuator of the cantilever 105 to maintain a constant interval between the probe tip 104 and the sample 130, and actuating the stage 101 in the direction of the X-axis. The sample 130 may be scanned while continuously actuating the stage 101, and all regions of the sample 130 may be precisely scanned at a high speed through a long stroke.

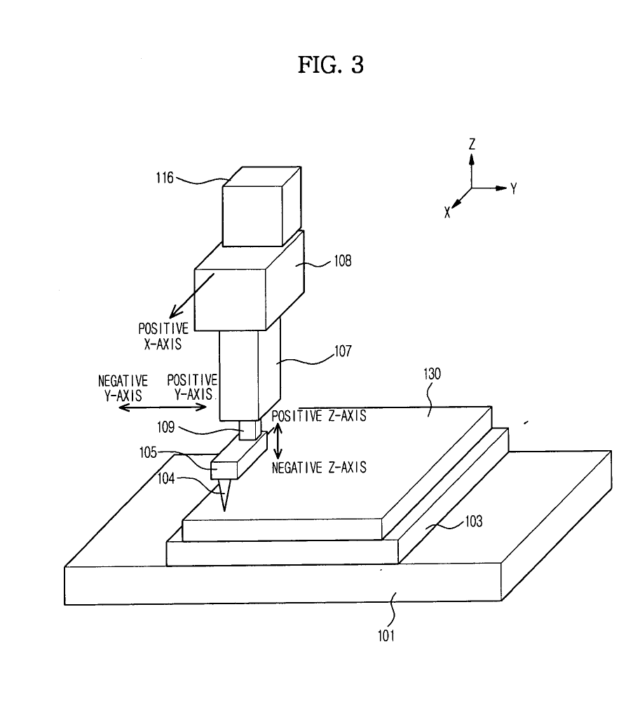

FIG. 3 is a perspective view illustrating methods of scanning samples using sample inspection apparatuses in accordance with still other example embodiments. Referring to FIG. 3, some regions of the sample 130 may be scanned by vibrating the quartz resonator scanner 107 at a high speed in the positive Y-axis and negative Y-axis directions, actuating the Z-axis actuator of the main scanner 108 and/or the Z-axis actuator of the cantilever 105 to maintain a constant interval between the probe tip 104 and the sample 130, and actuating the main scanner 108 in the X-axis direction. The stage 101 may be actuated to transfer the sample 130 to a different position and then other regions of the sample 130 may be scanned in the same manner. The stage 101 may be stopped during the scanning of some regions of the sample 130, and the stage 101 may be actuated to transfer the sample 130 to a different position and other regions of the sample 130 may be scanned after the scanning of some regions of the sample 130 is completed. The partial regions of the sample 130 may be individually and precisely scanned at a high speed.

The controller 134 may supply AC voltage and DC voltage to the sample 130 and the cantilever 105 through the voltage supplier 106, thereby including electrostatic force between the sample 130 and the probe tip 104 due to Coulomb force and capacitive force. AC voltage may be used to induce electrostatic force fluctuating between the sample 130 and the probe tip 104, and DC voltage may be used to induce constant electrostatic force between the sample 130 and the probe tip 104. In order to prevent and/or reduce electrical shorts between the cantilever 105 and the sample 130 if the cantilever 105 and the sample 130 come into physical contact, the surface of the cantilever 105 may be coated with an insulating oxide layer.

The controller 134 may measure a vibration displacement of the cantilever 105 when the cantilever 105 is vibrated by the induced electrostatic force between the sample 130 and the probe tip 104, convert the measured vibration displacement of the cantilever 105 into a surface topography of the sample 130 (e.g., a topographical map) and display the surface topography of the sample 130 (e.g., display an image of the topographical map). The controller 134 may convert the vibration displacement value of the cantilever 105 into an amplitude and a phase of the cantilever 105 corresponding to the surface topography of the sample 130 through the sample surface topography lock-in amplifier 123, generate the surface topography of the sample 130 from the amplitude and phase, and display the generated surface topography of the sample 130 through the sample surface topography display 124. The controller 134 may measure the vibration displacement of the cantilever 105 when the cantilever 105 is vibrated by the induced electrostatic force between the sample 130 and the probe tip 104, convert the measured vibration displacement of the cantilever 105 into data (e.g., a surface potential of the sample 130 and/or a capacitance of the sample 130) and display the data.

If DC voltage of the voltage supplier 106 is fixed, a relative surface potential of the sample 130 may be imaged from a vibration displacement variation of the cantilever 105. If the DC voltage of the voltage supplier 106 is measured while the controller 134 varies the DC voltage of the voltage supplier 106 such that a frequency component output value of the sample surface potential lock-in amplifier 125 becomes zero, an absolute surface potential of the sample 130 may be imaged from the vibration displacement variation of the cantilever 105. The controller 134 may convert the vibration displacement value of the cantilever 105 into an amplitude and a phase of the cantilever 105 corresponding to the surface potential of the sample 130 through the sample surface potential lock-in amplifier 125, generate the surface potential of the sample 130 from the amplitude and phase, and display the generated surface potential of the sample 130 through the sample surface potential display 126. The controller 134 may convert the vibration displacement value of the cantilever 105 into an amplitude and a phase of the cantilever 105 corresponding to the capacitance of the sample 130 through the sample capacitance lock-in amplifier 127, generate the capacitance of the sample 130 from the amplitude and phase, and display the generated capacitance of the sample 130 through the sample capacitance display 128.

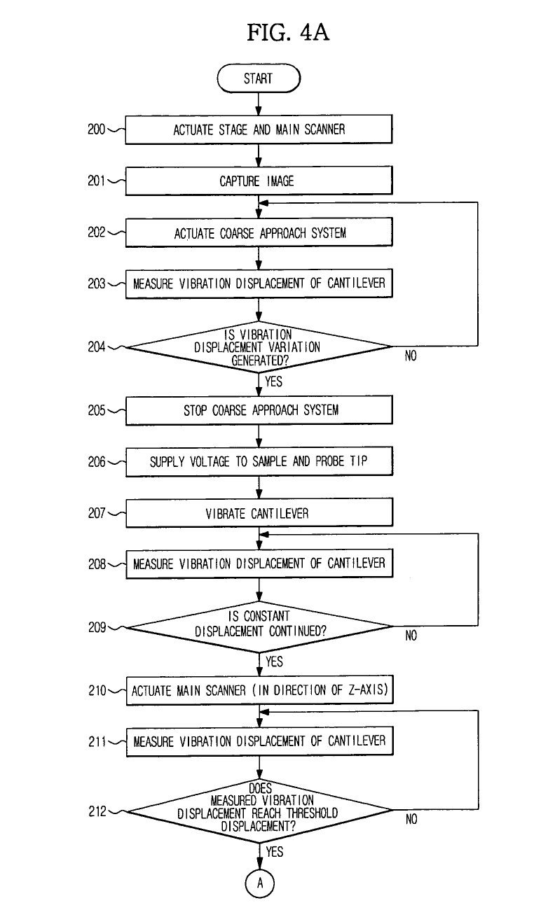

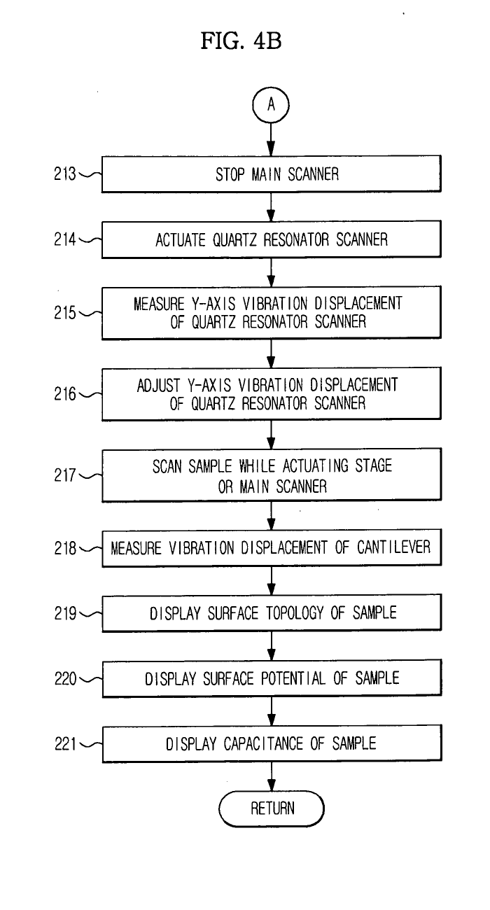

FIGS. 4A and 4B are flow charts illustrating sample inspection methods using sample inspection apparatuses in accordance with yet other example embodiments. Referring to FIGS. 4A and 4B, vibration of the stage 101 may be isolated by the isolators 102 and the sample 130 may be fixed to the stage 101 by the chuck 103. The cantilever 105 may be fixed by the cantilever fixing module 109 and an output value of the piezo resistive sensor of the cantilever 105 may be set to zero. The controller 134 may supply voltage to the stage 101 through the amplifier 120 for the stage 101 to actuate the stage 101 and may supply voltage to the main scanner 108 through the amplifier 113 for the main scanner 108 such that the cantilever 105 is located at a desired position of the sample 130 (operation 200).

After the controller 134 actuates the stage 101 and the main scanner 108, the controller 134 may capture an image through the optical system 117 so as to check whether or not the cantilever 105 is located at the desired position of the sample 130 (operation 201). The captured image may be displayed on the optical image display 129. The controller 134 may control actuations of the stage 101 and the main scanner 108 using the captured image, thereby locating the cantilever 105 at the desired position of the sample 130. When the cantilever 105 is located at the desired position of the sample 130, the controller 134 may stop the stage 101 and the main scanner 108, and actuate the coarse approach system 116 through the amplifier 119 for the coarse approach system 116 such that the quartz resonator scanner 107 and the main scanner 108 approach the sample 130 (operation 202).

When the quartz resonator scanner 107 and the main scanner 108 approach the sample 130 through the coarse approach system 116, as a distance between the probe tip 104 attached to the cantilever 105 and the sample 130 decreases, attractive force between atoms of the probe tip 104 attached to the cantilever 105 and atoms of the sample 130 may be increased and thus the probe tip 104 may move toward the sample 130. The cantilever 105 to which the probe tip 104 is attached may be bent in the direction of the sample 130 and the actuation displacement of the cantilever 105 may be varied. When the quartz resonator scanner 107 and the main scanner 108 approach the sample 130, the controller 134 may measure the vibration displacement of the cantilever 105 using the piezo resistive sensor of the cantilever 105 (operation 203).

The controller 134 may judge whether or not the vibration displacement of the cantilever 105 is varied (operation 204). When the vibration displacement of the cantilever 105 is varied, controller 134 may stop the coarse approach system 116 such that movements of the main scanner 108 and the quartz resonator scanner 107 toward the sample 130 are stopped (operation 205). The controller 134 may supply AC voltage and DC voltage to the sample 130 and the cantilever 105 through the voltage supplier 106 (operation 206). Electrostatic force may be induced between the sample 130 and the probe tip 104 due to Coulomb force and capacitive force. The controller 134 may vibrate the cantilever 105 by actuating the piezoelectric actuator of the thermal actuator of the cantilever 105 (operation 207). The controller 134 may measure a vibration displacement of the cantilever 105 using the piezo resistive sensor of the cantilever 105 (operation 208).

The controller 134 may judge whether or not the measured vibration displacement remains constant (operation 209). If the measured vibration displacement does not remain constant, the controller 134 may be returned to operation 208 and stand by until the measured vibration displacement remains constant. If the measured vibration displacement remains constant, the controller 134 may actuate the main scanner 108 such that the probe tip 104 of the cantilever 105 moves toward the sample 130 (operation 210). When the main scanner 108 is actuated to move the cantilever 105 toward the sample 130, the vibration displacement of the cantilever 105 may be varied according to interaction between atoms of the probe tip 104 attached to the cantilever 105 and atoms of the sample 130. About simultaneously with the movement of the probe tip 104 of the cantilever 105 toward the sample 130, the controller 134 may measure the vibration displacement of the cantilever 105 through the piezo resistive sensor of the cantilever 105 (operation 211).

The controller 134 may judge whether or not the measured vibration displacement reaches a displacement threshold (operation 212). If it is judged, as a result of operation 212, that the measured vibration displacement does not reach the displacement threshold, the controller 134 may be returned to operation 211 and stand by until the measured vibration displacement reaches the displacement threshold. If it is judged, as the result of operation 212, that measured vibration displacement reaches the displacement threshold, the controller 134 may stop the main scanner 108 so as to stop the movement of the cantilever 106 toward the sample 130 (operation 213). The scanner 134 may actuate the quartz resonator scanner 107 to allow vibration of the quartz resonator scanner 107 in the positive Y-axis and the negative Y-axis directions (operation 214). The quartz resonator scanner 107 may be vibrated at a high speed by the quartz resonator and the sample 130 may be scanned at a high speed in the Y-axis direction.

The controller 134 may measure current generated from the quartz resonator of the quartz resonator scanner 107 through the current measuring device 112 for the quartz resonator scanner 107, and/or measure a Y-axis vibration displacement of the quartz resonator scanner 107 through the displacement measuring device 115 for the quartz resonator scanner 107 (operation 215). In order to allow the Y-axis vibration displacement of the quartz resonator scanner 107 to maintain the displacement, the controller 134 may adjust voltage supplied to the quartz resonator scanner 107 through the voltage supplier 111 for the quartz resonator scanner 107 such that the output value of the current measuring device 112 for the quartz resonator scanner 107 and/or the output value of the displacement measuring device 115 for the quartz resonator scanner 107 reaches a threshold value (operation 216).

About simultaneously with the vibration of the cantilever 105 to achieve the threshold vibration displacement, the controller 134 may actuate the stage 101 in the direction of the X-axis while facilitating the Y-axis vibration displacement of the controller 134 to maintain the displacement, and/or fix the stage 101 and actuate the main scanner 108 in the direction of the X-axis, thereby scanning (e.g., precisely scanning) the sample 130 at a high speed (operation 217). Here, the scanning of the sample 130 is achieved in a tapping mode through which the probe tip 104 taps the sample 130 or a non-contact mode through which the probe tip 104 does not contact the sample 130.

Under the condition that the sample is scanned by vibrating the cantilever 105 to have the threshold vibration displacement, facilitating the Y-axis vibration displacement of the quartz resonator scanner 107 to maintain the threshold displacement, and actuating the stage 101 in the direction of the X-axis and/or fixing the stage 101 and then actuating the main scanner 108 in the direction of the X-axis, the controller 134 may measure a vibration displacement variation of the cantilever 105 using the piezo resistive sensor of the cantilever 105 (operation 218). The vibration displacement variation of the cantilever 105 may be measured using the piezo resistive sensor of the cantilever 105 while constantly controlling the vibration displacement of the cantilever 105 in the tapping mode or in the non-contact mode between the probe top 104 and the sample 130. If the cantilever 105 is vibrated in the non-contact mode between the probe tip 104 and the sample 130, a vibration frequency variation and/or a vibration phase variation of the cantilever 105 instead of the vibration displacement variation of the cantilever 105 may be measured. A surface topography, a surface potential and a capacitance of the sample 130 may be detected using the vibration frequency variation or the vibration phase variation.

The controller 134 may convert a vibration displacement value of the cantilever 105 into an amplitude and a phase of the cantilever 105 representing the surface topography of the sample 130 through the sample surface topography lock-in amplifier 123, generate the surface topography of the sample 130 from the amplitude and phase, and display the generated surface topography of the sample 130 through the sample surface topography display 124 (operation 219). The controller 134 may convert the vibration displacement value of the cantilever 105 into an amplitude and a phase of the cantilever 105 representing the surface potential of the sample 130 through the sample surface potential lock-in amplifier 125, generate the surface potential of the sample 130 from the amplitude and phase, and display the generated surface potential of the sample 130 through the sample surface potential display 126 (operation 220). The controller 134 may fix DC voltage through the voltage supplier 106 and obtain a relative surface potential of the sample 130 from the vibration displacement variation of the cantilever 105. The controller 134 may measure DC voltage of the voltage supplier 106 while varying the DC voltage of the voltage supplier 106 such that a frequency component output value of the sample surface potential lock-in amplifier 125 becomes zero and obtain an absolute surface potential of the sample 130.

The controller 134 may convert the vibration displacement value of the cantilever 105 into an amplitude and a phase of the cantilever 105 representing the capacitance of the sample 130 through the sample capacitance lock-in amplifier 127, generate the capacitance of the sample 130 from the amplitude and phase, and display the generated capacitance of the sample 130 through the sample capacitance display 128 (operation 221).

Sample inspection apparatuses and sample inspection methods according to some example embodiments may include scanning a sample at a high speed while inducing electrostatic force due to an electric field generated between a probe tip and the sample, and generate and display a surface topography of the sample from a vibration displacement variation of a cantilever due to the electrostatic force, thereby detecting defects (e.g., rapidly and precisely) of the sample without damage to the surface of the sample.

Sample inspection apparatuses and sample inspection methods according to example embodiments may include operating in general atmospheric environments, compared with a sample inspection method using an electron beam, and thus may not require a vacuum pump and/or vacuum chamber and may omit time necessary to create a vacuum state, and may not use an electron beam and reduce and/or prevent damage to the sample. Sample inspection apparatuses and sample inspection methods according to example embodiments may overcome limited resolution for detection of defects of the sample, compared with a sample inspection method using an optical system, thereby detecting fine defects of the sample. Sample inspection apparatuses and sample inspection methods according to example embodiments may image a surface potential and a capacitance of the sample, compared with the sample inspection method using the electron beam and the sample inspection method using the optical system, thereby inspecting whether or not substances constituting the sample are uniformly distributed in the sample.

While example embodiments have been particularly shown and described, it will be understood by one of ordinary skill in the art that variations in form and detail may be made therein without departing from the spirit and scope of the claims.

What is claimed is:

1. A sample inspection apparatus, comprising:
a cantilever including a probe tip, the cantilever configured such that a vibration displacement of the cantilever varies according to electrostatic force induced between the probe tip and a sample;
a displacement sensor configured to measure the vibration displacement of the cantilever;
an actuator configured to vibrate the cantilever;
a first scanner configured to vibrate the cantilever in a scanning direction of the sample;
a voltage supply configured to supply voltage to the probe tip and the sample to induce the electrostatic force; and
a controller configured to actuate the actuator and the first scanner to scan the sample and to control generation of surface topography data of the sample based on the vibration displacement measured during scanning of the sample.

2. The apparatus of claim 1, wherein
the controller includes a lock-in amplifier configured to output amplitude and phase data of the cantilever corresponding to a surface topography of the sample based on the measured vibration displacement of the cantilever, and
the controller is configured to generate the surface topography data of the sample based on the amplitude and phase data of the cantilever output from the lock-in amplifier.

3. The apparatus of claim 2, further comprising:
a surface topography display configured to display the surface topography data of the sample generated by the controller.

4. The apparatus of claim 1, wherein
the controller includes a lock-in amplifier configured to output amplitude and phase data of the cantilever corresponding to a surface potential of the sample based on the measured vibration displacement of the cantilever, and
the controller is configured to generate surface potential data of the sample based on the amplitude and phase data of the cantilever output from the lock-in amplifier.

5. The apparatus of claim 1, wherein
the controller includes a lock-in amplifier configured to output amplitude and phase data of the cantilever corresponding to capacitance of the sample based on the measured vibration displacement of the cantilever, and
the controller is configured to generate capacitance data of the sample based on the amplitude and phase data of the cantilever output from the lock-in amplifier.

6. The apparatus of claim 1, wherein
the actuator is configured to vibrate the cantilever in a Z-axis direction, and
the first scanner is configured to vibrate the cantilever in a Y-axis direction.

7. The apparatus of claim 6, further comprising:
a second scanner configured to move the first scanner in an X-axis direction, and in the Y-axis and Z-axis directions, and to rotate the first scanner in the Z-axis direction, and configured to move in the X-axis direction during scanning of the sample.

8. The apparatus of claim 6, further comprising:
a stage configured to move the sample in an X-axis direction, and in the Y-axis and Z-axis directions, and to rotate the sample in the Z-axis direction, and configured to move in the X-axis direction during scanning of the sample.

9. The apparatus of claim 7, further comprising:
an implement attaching the first scanner to the second scanner.

10. The apparatus of claim 1, further comprising:
an electrically insulating layer on the surface of the cantilever, the electrically insulating layer configured to electrically isolate the cantilever from the sample.

11. A sample inspection apparatus, comprising:
a cantilever including a probe tip, the cantilever configured such that a vibration displacement of the cantilever varies according to electrostatic force induced between the probe tip and a sample;
a displacement sensor configured to measure the vibration displacement of the cantilever;
an actuator configured to vibrate the cantilever;
a quartz resonator scanner configured to vibrate the cantilever in a scanning direction of the sample;
a voltage supply configured to supply voltage to the probe tip and the sample to induce the electrostatic force; and
a controller configured to actuate the actuator and the quartz resonator scanner to scan the sample and to control generation of surface topography data, surface potential data, and capacitance data of the sample based on the vibration displacement measured during scanning of the sample.

12. The apparatus of claim 11, wherein the controller includes
a first lock-in amplifier configured to output amplitude and phase data of the cantilever corresponding to a surface topography of the sample based on the measured vibration displacement of the cantilever,
a second lock-in amplifier configured to output amplitude and phase data of the cantilever corresponding to a surface potential of the sample based on the measured vibration displacement of the cantilever, and
a third lock-in amplifier configured to output amplitude and phase data of the cantilever corresponding to capacitance of the sample based on the measured vibration displacement of the cantilever.

13. The apparatus of claim 12, wherein the controller is configured to generate the surface topography data of the sample based on an output signal of the first lock-in amplifier, generate the surface potential data of the sample based on an output signal of the second lock-in amplifier, and generate the capacitance data of the sample based on an output signal of the third lock-in amplifier.

14. The apparatus of claim 13, further comprising:
one or more displays configured to display the surface topography data, the surface potential data and the capacitance data of the sample based on a control signal of the controller.

15. A sample inspection method, comprising:
supplying voltage to a sample and to a probe tip of a cantilever;
vibrating the cantilever to obtain an about constant vibration displacement;
scanning the sample using a quartz resonator scanner that vibrates the cantilever in a direction parallel with the sample;
measuring the vibration displacement of the cantilever during the scanning of the sample;
generating surface topography data corresponding to a surface topography of the sample based on the measured vibration displacement of the cantilever; and
displaying the surface topography data.

16. The method of claim 15, wherein the scanning of the sample includes
vibrating the cantilever in the direction parallel with the sample using the quartz resonator scanner before the scanning of the sample,
measuring the vibration displacement of the cantilever in the direction parallel with the sample, and
adjusting a vibration displacement of the scanner such that the measured vibration displacement reaches a target vibration displacement.

17. The method of claim 16, further comprising:
generating surface potential data corresponding to a surface potential of the sample based on the measured vibration displacement of the cantilever; and
displaying the surface potential data.

18. The method of claim 17, further comprising:
generating capacitance data of the sample based on the measured vibration displacement of the cantilever; and
displaying the capacitance data

19. The apparatus of claim 14, wherein the surface topography data, the surface potential data and the capacitance data are displayed as wafer maps.

20. The apparatus of claim 1, wherein the first scanner is a quartz resonator scanner.
